(19) United States
(12) Patent Application Publication
(10) Pub. No.: US 2022/0327235 A1
(43) Pub. Date: Oct. 13, 2022

(54) ACCIDENT AND/OR BODILY INJURY MANAGEMENT AND MONITORING APPLICATION FOR LAW FIRMS, MEDICAL PROVIDERS, INSURANCE COMPANIES, PROCESS, SYSTEM, APPARATUS, AND A METHOD OF USING SAME

(71) Applicant: Tamerlan Rakhimbekov, Staten Island, NY (US)

(72) Inventors: Tamerlan Rakhimbekov, Staten Island, NY (US); Tetyana Safonova, Staten Island, NY (US)

(21) Appl. No.: 17/712,168

(22) Filed: Apr. 3, 2022

Related U.S. Application Data
(60) Provisional application No. 63/170,998, filed on Apr. 5, 2021.

(51) Int. Cl. G06F 21/62; G06Q 50/18

(52) U.S. Cl. CPC G06F 21/6245; G06Q 50/18

(57) ABSTRACT

The present invention relates generally to an accident and/or bodily injury management and monitoring application for law firms, medical providers, insurance companies, process, system, apparatus, and a method of using same. More particularly, the invention encompasses a software application that can be used via an electronic device to manage accident injury cases, such as, for example by law firms, medical providers, and insurance companies. The electronic device could be a computer, a smartphone, a tablet, to name a few. This inventive App or Application also gives a client of a law firm access to the database so that the client or a user can track, and follow detailed process of their case in real time. The App is for universal users, however, each user is limited to seeing information related to the at least one injured person that pertains or is of interest to the user.

### CROSS-REFERENCE TO RELATED APPLICATION

The instant patent application claims priority to and the benefit of pending U.S. Provisional Patent Application Ser. No. 63/170,998, filed on Apr. 5, 2021, titled “Accident Injury Management And Monitoring Application For Law Firms, Medical Providers, Insurance Companies, Process, System, And Apparatus Thereof,” the entire disclosure of which provisional application is incorporated herein by reference.

### FIELD OF THE INVENTION

The present invention relates generally to an accident and/or bodily injury management and monitoring application for law firms, medical providers, insurance companies, process, system, apparatus, and a method of using same. More particularly, the invention encompasses a software application that can be used via an electronic device to manage accident injury cases, such as, for example by law firms, medical providers, and insurance companies. The electronic device could be a computer, a smartphone, a tablet, to name a few. This inventive App or Application also gives a client of a law firm access to the database so that the client or a user can track, and follow detailed process of their case in real time. The App is for universal users, however, each user is limited to seeing information related to the at least one injured person that pertains or is of interest to the user.

### BACKGROUND INFORMATION

U.S. Pat. No. 5,956,687 (Vaughn A. Wamsley, et al.), the entire disclosure of which is incorporated herein by reference, a technique for computerized management of a plaintiffs personal injury case is disclosed. This technique includes establishing records, each reflective of the phase of a corresponding personal injury claim. The first phase corresponds to pre-negotiation of the claim and includes at least a first and second subordinate pre-negotiation stage. Each of these stages includes the generation of a number of prompts directed to obtaining information about the claim. A given record may also be set to a second management phase corresponding to negotiation of the claim or a third management phase representing settlement of the claim. In addition, the present invention discloses a technique to automatically generate a demand letter and calculate settlement amounts from information gathered in the record during pursuit of the claim. The management system may also include scheduling various prompts and correspondence with the program in accordance with a predetermined schedule spanning several days.

U.S. Pat. No. 6,098,070 (John M. Maxwell), the entire disclosure of which is incorporated herein by reference, discloses an electronic case manager for a personal injury plaintiffs law office in which client and defendant level data related to an injury incident are collected and organized in an efficient manner. The electronic case manager includes a relational database having a number of tables, and a database management program.

U.S. Pat. No. 6,810,382 (Vaughn A. Wamsley, et al.), the entire disclosure of which is incorporated herein by reference, a technique for computerized management of a plaintiffs personal injury case is disclosed. This technique includes establishing records, each reflective of the phase of a corresponding personal injury claim. The first phase corresponds to pre-negotiation of the claim and includes at least a first and second subordinate pre-negotiation stage. Each of these stages includes the generation of a number of prompts directed to obtaining information about the claim. A given record may also be set to a second management phase corresponding to negotiation of the claim or a third management phase representing settlement of the claim. In addition, the present invention discloses a technique to automatically generate a demand letter and calculate settlement amounts from information gathered in the record during pursuit of the claim. The management system may also include scheduling various prompts and correspondence with the program in accordance with a predetermined schedule spanning several days.

U.S. Pat. No. 8,478,672 (Robert McHugh, et al.), the entire disclosure of which is incorporated herein by reference, and in accordance with one or more embodiments, discloses a method of operating an insurance claim management system provides for receiving, in a claim reporting system, information related to a report of a injury claim, the information being provided by an insurance medical liaison located at a location at which the injured worker's injury has been evaluated. The information may also be indicative of an evaluation, by the insurance medical liaison, of at least one of a work-related injury and an injured worker. The method further provides for establishing a record in the claim reporting system for the claim based at least in part on the information received from the insurance medical liaison.

US Patent Publication No. 20120284052 (Sandra Lombardi Saukas, et al.), the entire disclosure of which is incorporated herein by reference, discloses a CIA (Comprehensive Initial Assessment) tool which provides a detailed initial assessment to tell the user of the tool what interaction is needed from the beginning of the injury. The CIA tool uses an innovative predictive scoring methodology to provide predictors on the risk of the clinical outcome of a worker's compensation claim. The CIA tool will help the nurse to manage the claim better as the tool includes specialty assessments to determine longer deviation and outcome of the claim. The CIA tool generates and provides a detailed blue print for case management and summary forms may be provided to the adjuster and/or case manager.

US Patent Publication No. 20210319519 (Alexander Tsao), the entire disclosure of which is incorporated herein by reference, relates generally to a claim management system and method for processing legal claims in the personal injury industry, including medical and insurance related administrative procedures. More so, the claim management system and method provides an innovative portal for a user to digitally process a claim through guided workflows generating detailed tasks and documents tailored for that claim as well as tracking claim information and progress, facilitating open communications and document sharing between all involved parties to a claim. Through key modules within the claim management system and method, a robust framework is created to revolutionize personal injury industry standards through reductions in legal fees, decreases in claim duration, and ultimately, fostering an environment of transparency and trust between all parties at an unprecedented level.

This invention improves on the deficiencies of the prior art and provides an inventive accident and/or bodily injury management and monitoring application for law firms, medical providers, insurance companies, process, system, apparatus, and a method of using same.

### PURPOSES AND SUMMARY OF THE INVENTION

The invention is a novel accident and/or bodily injury management and monitoring application for law firms, medical providers, insurance companies, process, system, apparatus, and a method of using same.

Therefore, one purpose of this invention is to provide an accident and/or bodily injury management and monitoring application for law firms, medical providers, insurance companies, process, system, apparatus, and a method of using same.

Another purpose of this invention is to provide an inventive App or Application which gives a user or a client of a law firm access to the database so that the client or a user can track, and follow detailed process of their case.

Yet another purpose of this invention is to provide an inventive App for a person who was a victim of a personal injury, and who has engaged a law firm to handle the claims and related matters.

Still yet another purpose of this invention is to provide an inventive App for universal users, where each user is limited to seeing information related to the at least one injured person that pertains or is of interest to the user.

Therefore, in one aspect this invention comprises an apparatus for managing communications between users, comprising;

(a) at least one electronic device having a device screen, and at least one software management system;
(b) said software management system being accessible to a user via a login page visible on said device screen;
(c) wherein upon login said user has access to at least one first page, wherein said at least one first page has information related to a personal injury of at least one person;
(d) wherein said at least one first page allows said user to obtain said information related to said personal injury of said at least one person; and
(e) wherein said user is limited to seeing information related to said at least one injured person that pertains to said user.

In another aspect this invention comprises a method of managing communications between users, comprising the steps of;

(a) making a user login onto a welcome page of an app by entering a username and a password;
(b) authenticating said user, and taking said user to a user agreement page;
(c) upon agreeing with said user agreement, allowing said user to enter said app, and wherein said app provides information related to at least one injured person;
(d) wherein said user is one of said at least one injured person, an employee of a law firm, a medical services provider, an insurance company employee, and combinations thereof; and
(e) wherein said user is limited to seeing information related to said at least one injured person that pertains to said user.

In another aspect this invention comprises a non-transitory computer-readable storage medium with an executable program application stored thereon, the program application configured for coordinating to perform transactions associated with managing communications between users, the program application configured to be accessible over a communications network, wherein the program application instructs a computer processor to perform the following steps of:

(a) making a user login onto a welcome page of an app by entering a username and a password;
(b) authenticating said user, and taking said user to a user agreement page;
(c) upon agreeing with said user agreement, allowing said user to enter said app, and wherein said app provides information related to at least one injured person;
(d) wherein said user is one of said at least one injured person, an employee of a law firm, a medical services provider, an insurance company employee, and combinations thereof; and
(e) wherein said user is limited to seeing information related to said at least one injured person that pertains to said user.

### BRIEF DESCRIPTION OF THE DRAWINGS

FIG. 1, is a screenshot of an electronic device having a display screen for the inventive App illustrating a welcome or home page.

FIG. 2, is a screenshot of an electronic device having a display screen for the inventive App illustrating a user agreement screen or page.

FIG. 3, is a screenshot of an electronic device having a display screen for the inventive App illustrating a list of provider(s) on a provider's screen or page.

FIG. 4, is a screenshot of an electronic device having a display screen for the inventive App illustrating a summary on a summary screen or page.

FIG. 5, is a screenshot of an electronic device having a display screen for the inventive App illustrating a Bills report on a bills report screen or page.

FIGS. 6, and 7, are a screenshot of an electronic device having a display screen for the inventive App illustrating a Case info or information on a first case info screen or page.

FIG. 8, is a screenshot of an electronic device having a display screen for the inventive App illustrating a second page for the Case info or information on a second case info screen or page, and is related to uploading document(s) onto a server for a specific case.

FIG. 9, is a screenshot of an electronic device having a display screen for the inventive App illustrating a Summary report on a summary report screen or page.

FIG. 10, is a screenshot of an electronic device having a display screen for the inventive App illustrating a settings on a settings screen or page.

FIG. 11, is a screenshot of an electronic device having a display screen for the inventive App illustrating a Bills info or information on a bills info screen or page.

FIG. 12, is a screenshot of an electronic device having a display screen for the inventive App illustrating a Filter on a filter screen or page.

### DETAILED DESCRIPTION

The inventive accident and/or bodily injury management and monitoring application for law firms, medical providers, insurance companies, process, system, apparatus, and a method of using same will now be discussed with reference to FIGS. 1 through 12. Although the scope of the present invention is much broader than any particular embodiment, a detailed description of the preferred embodiment follows together with drawings. These drawings are for illustration purposes only and are not drawn to scale. Like numbers represent like features and components in the drawings.

The inventive App can also be used by a medical provider that can send to the law firm their outstanding cases so that the law firm can collect money from insurance companies through arbitration, and litigation. Each medical provider or user or client has their own access to the database through login, and password, so that they can see, for example, when their particular case was filed, any past, current, or future hearing date, any motion(s) that have been filed, etc., to name a few. Medical provider(s) are also able to see the amount that was filed with the court or for arbitration, any amount that has been collected, any outstanding amount of money that insurance company owes, to name a few.

The user or medical provider is also able to see the invoices, with the amounts that they owe to the law firm for its legal services, etc. The user or the medical provider is also able to make payments to the law firms directly through this inventive App. Similarly, the user or the medical provider(s) are also able to see any correspondence between the law firm, and the insurance companies. The user or the medical provider is also able to see the retainer, and sign it online, upload documentation, schedule appointments for IME, (an IME is defined as “the evaluation of an injured party that utilizes a third party, independent medical professional to issue an unbiased opinion on the injury”), EUO, (an examination under oath (EUO) is an important tool to help an insured prove his or her loss or to allow an insurer to cross-examine the proofs of loss to avoid potential fraud), get reminders, and have direct connection with the attorney assigned to their case, download full report of each case, to name a few. Clients or user are also able to see all the due dates so the law firm will not accidentally miss anything. Thus, the client(s), user(s), medical providers, etc., are able to track every single detailed step of their case.

Thus, it should be appreciated that the inventive accident and/or bodily injury management and monitoring application for law firms, medical providers, insurance companies, process, system, apparatus, and a method of using same is an open system, and is accessible to all parties who are involved in the management, and/or monitoring of the wellbeing of an injured person, including the injured person. All documents and fields are openly accessible by each party, and thus the whole process is transparent. Due to privacy concerns a user or client has to go through an authentication process, and once authenticated the user or client can freely roam around the inventive App, and get real-time information or data that maybe of interest to the user or client.

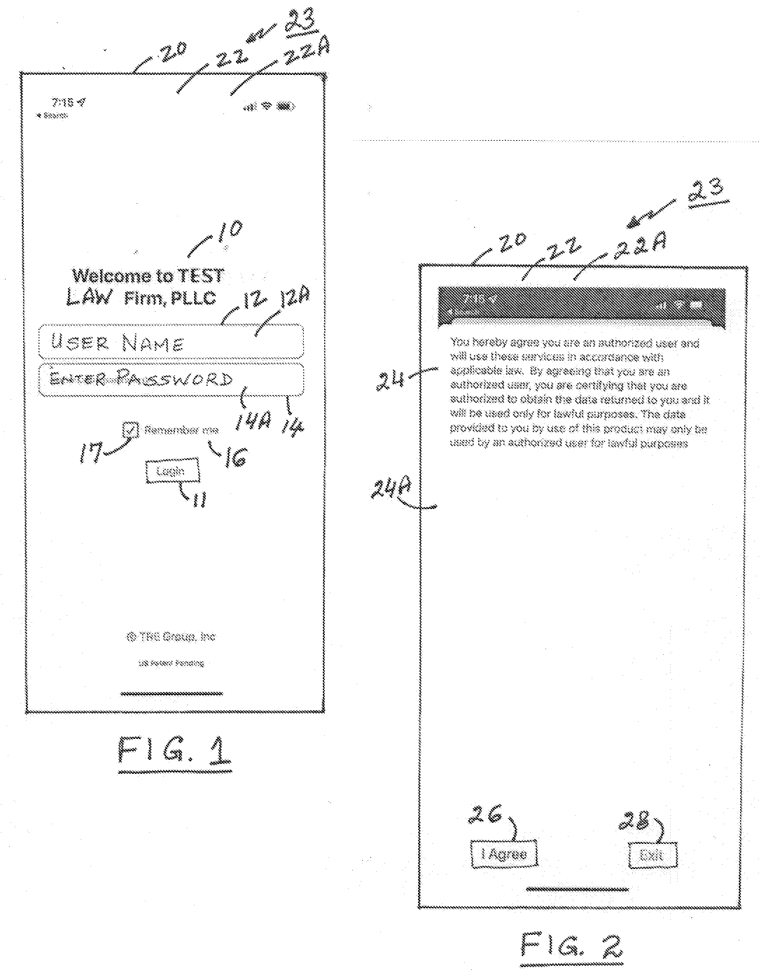

FIG. 1, is a screenshot of an electronic device 20, having a display screen 22, for an inventive App 23, illustrating a welcome or home page 22A, for a law firm 10. The electronic device 20, could be selected from a group comprising a smartphone, a mobile phone, a cellular phone, an iPad, a tablet, a computer, and combinations thereof, to name a few. The screenshot of FIG. 1, shows the home or login page or screen for the inventive App 23. The inventive App 23, essentially comprises of an accident injury management and monitoring application for law firms, medical providers, insurance companies, process, system, and apparatus thereof 23. As one can appreciate that the inventive App 23, allows a user (not shown) to enter the inventive App 23, using several security features, such as, for example, asking the user to enter the inventive App 23, by inputting the user's login information 12, such as, for example, a username 12A, and then entering a security information 14, such as, for example, a user password 14A. For the ease of understanding the inventive App 23, it is assumed that the user is an authorized user, or that the user has already established himself/herself as a user of the inventive App 23, by providing the username 12A, and password 14A, during an initial login, or that the administrator of the inventive App 23, may have provided the user with the username 12A, and password 14A. However, it should also be understood that this home screen of FIG. 1, or another screen (not shown) could also be used to establish the credentials of a new user, so as to allow the user to use the inventive App 23. For example, for some applications one could use a two-factor authentication process to establish the credentials of a new user, or to authenticate the user, if for example, the user is using a new electronic device 20, such as, for example, a new mobile phone, an iPad, a tablet, a computer, or similar such electronic device 20. For some applications the user could also have the option to check or uncheck the box 17, which is a “Remember me” box 16, as that would allow a user to enter the inventive App 23, without going through one or more initial login steps. After the user has completed the initial login steps the user would the press or activate the login button 11, to enter the inventive App 23, which would take the user to a next screen, such as, for example, a User Agreement screen or page 24A, illustrated in FIG. 2. For some applications, a user would pick his or her username 12, and the password 14, when logging in into the inventive App 23, at home or welcome page 22A, for the law firm 10, while for some other applications, a user would be provided with a unique username 12, and a unique password 14, by an administrator (not shown) of the inventive App 23, or it could be a unique username 12, and a unique password 14, generated by the electronic device 20, for that user. The username 12, and the password 14, could be for a single use, or multiple-entry use, or for a limited number of times use, to name a few, as this way the inventive App 23, controls the number of times or attempts that a user could access the inventive App 23, and thus this way the inventive App 23, provides a sunset or a termination of access for a user.

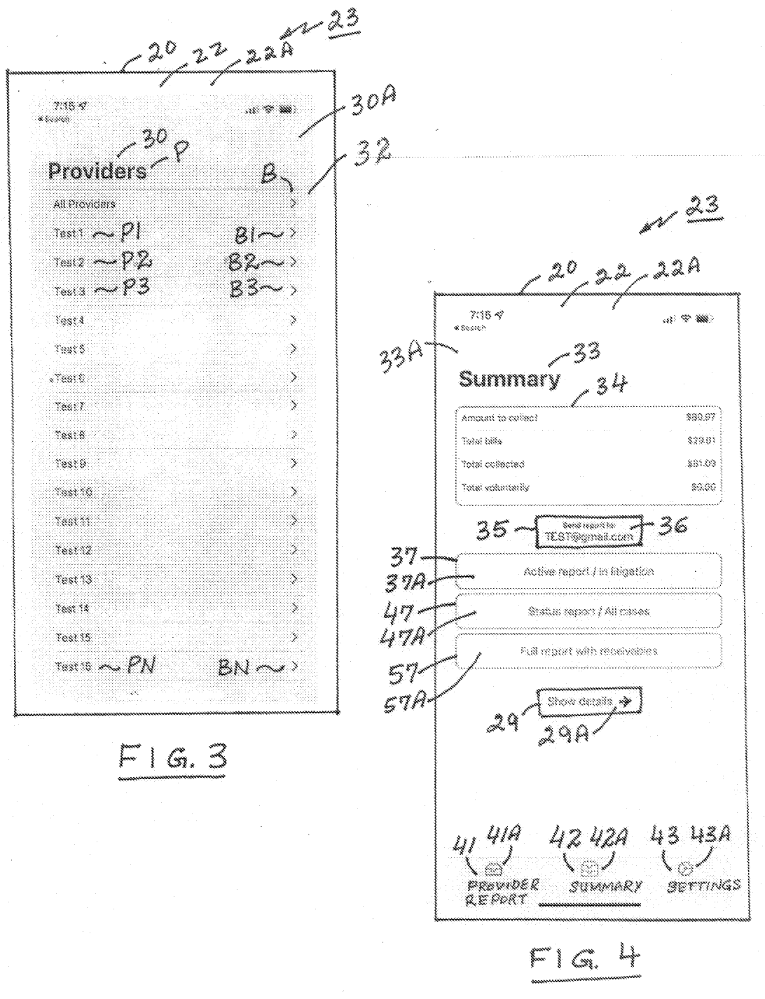

FIG. 2, is a screenshot of an electronic device 20, having a display screen 22, for the inventive App 23, illustrating a user agreement screen or page 24A. The user agreement screen or page 24A, is reached when a user clicks on the login button 11, in FIG. 1. On the user agreement screen or page 24A, the user is shown a user or disclosure agreement 24, which the user could accept by clicking or activating the agree button 26, or click on an exit button 28, to leave or exit the inventive App 23. Once a user clicks or activates the “I Agree” button 26, the user is then taken to the next screen, such as, for example, a provider screen or page 30A, illustrated in FIG. 3.

FIG. 3, is a screenshot of an electronic device 20, having a display screen 22, for the inventive App 23, illustrating a list of provider(s) P, 30, on a provider's screen or page 30A. The list of providers screen or page 30A, is reached when a user clicks on the “I Agree” button 26, illustrated in FIG. 2. It should be appreciated that the list of all assigned medical offices or providers P, 30, are now available to a user or client or an accident injured person to select or choose from. The list of providers screen or page 30A, has a list of providers P1, P2, P3, . . . , PN. With the list of providers P1, P2, P3, . . . , PN, a user is also provided with a button B, 32, where the buttons B1, B2, B3, . . . , BN, directly correspond to the corresponding list of providers P1, P2, P3, . . . , PN, and pressing or clicking any of the button B, would take the user to another page that would have some additional details or information for that provider(s) P, 30. If the user or client selected “All Providers”, then a list will be generated or shown to the user or requester, and then the user or requester could choose one or more provider P, 30, from the generated list.

FIG. 4, is a screenshot of an electronic device 20, having a display screen 22, for the inventive App 23, illustrating a summary 33, on a summary screen or page 33A. The summary screen or page 33A, is reached when a user clicks on the provider button B, 32, illustrated in FIG. 3. On this page or screen 33A, one could have additional summary display 34, where a user would get additional information, such as, for example, the “Amount to collect”, “Total bills” or total invoices to date, “Total collected”, “Total voluntarily” collected or obtained, to name a few. This additional summary display 34, would basically display the amounts outstanding or collected from a source, such as, for examples, an Insurance Company, or the amount that the Insurance companies have voluntarily paid towards the expenses or compensation while the case is in process or has been concluded, etc. The summary page or screen 33A, could also have additional fields, such as, for example, a print screen 35, which could be provided with a send to print button 36, or send an email button 36, “Active report/In litigation” 37, which could be reached by activating or clicking on the button 37A, “Status report/All cases” 47, which could be reached by activating or clicking on the button 47A, “Full report with receivables” 57, which could be reached by activating or clicking on the button 57A, “Show details” 29, which could be reached by activating or clicking on the button 29A, “Provider Report” or provider report logo 41, which could be reached by activating or clicking on the button 41A, “Summary” or summary logo 42, which could be reached by activating or clicking on the button 42A, “Settings” or setting logo 43, which could be reached by activating or clicking on the button 43A, to name a few. It should be appreciated that these various fields on the summary page or screen 33A, are for illustration purposes, and additional fields could also be provided or customized for a specific user or customer or client. It should be appreciated that the summary 33, could be a financial summary 33, that lists all the reports, such as, for example, Active report/In litigation 37, which could include cases that are in litigation or arbitration, Status report/All cases 47, which would allow a user to access all cases, Full report with receivables 57, which would give a user information on cases that have already been paid with dates and amounts, etc. For each of the requested information a user or requestor could also filter the requested information, such as, by week, month, year, day, or any custom range.

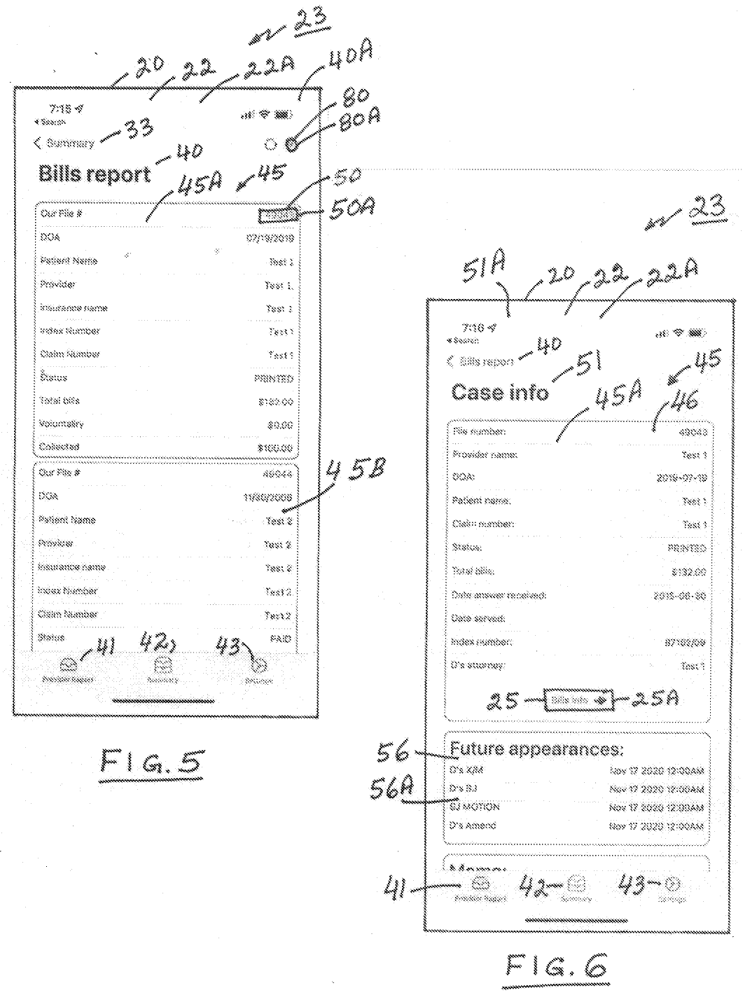

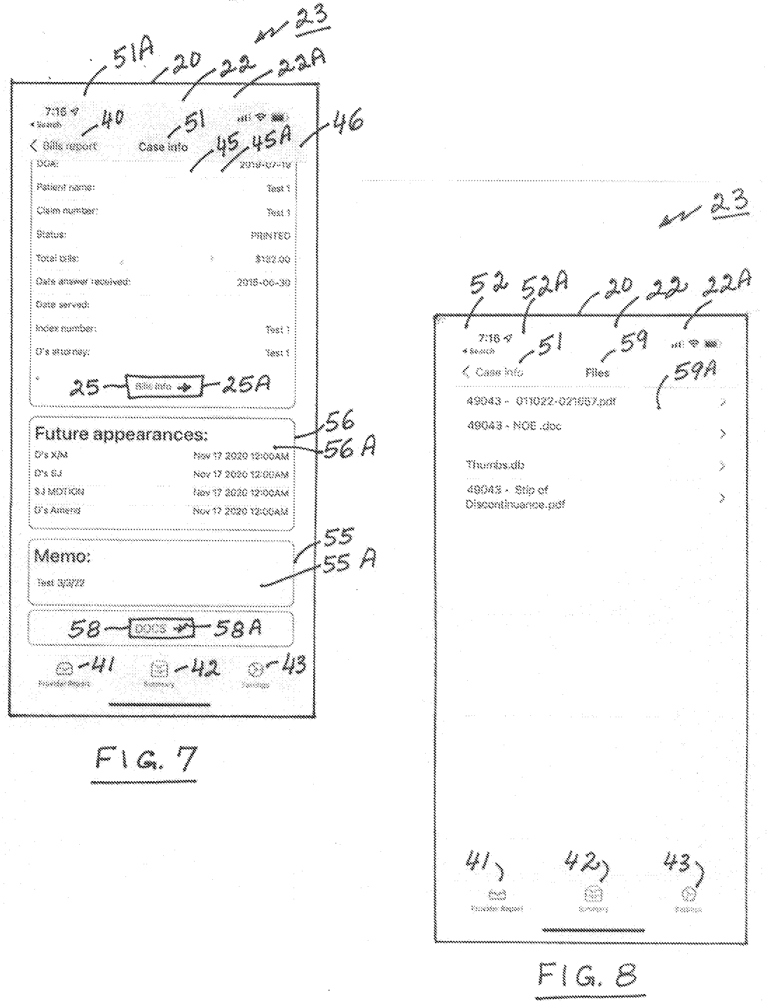

FIG. 5, is a screenshot of an electronic device 20, having a display screen 22, for the inventive App 23, illustrating a Bills report 40, on a bills report screen or page 40A. The bills report screen or page 40A, is reached when a user clicks on the show details button 29A, illustrated in FIG. 4. On the bills report page or screen 40A, the user would get additional information, such as, for example, for a specific case 45, any of the additional supporting information, such as, for example, a file number, DOA (Date of Accident), Patient Name or injured person's name, Provider name, Insurance company name, Index number, Claim number, the current “status” of the specific file, “Total bills” that have been generated or sent to the Insurance Company, any “Voluntarily” payment or any advance payment by the Insurance Company, any amount that has already been “collected” from the Insurance company, to name a few. For the purposes of illustration, the bills report page or screen 40A, has been illustrated with two different cases, such as, for example, a first specific case 45A, and a second specific case 45B, however, a user could scroll down the bills report screen or page 40A, for any of the additional specific case(s) 45. Additionally, if a user wants any additional information, such as, for example, on the first specific case 45A, the user would click or activate button 50A, for the file number 50, and the user would then be taken to the next screen which would have the additional information for the file number 50, such as, for example, the screens or pages shown in FIGS. 6, and 7. The bills report screen or page 40A, could also have a filter button or logo 80, which could be activated via filter button 80A, which would take a user to a filter screen or page 85A, illustrated in FIG. 12. It should be appreciated that the Bills Report 40, provides a list of all claims with balances and related information.

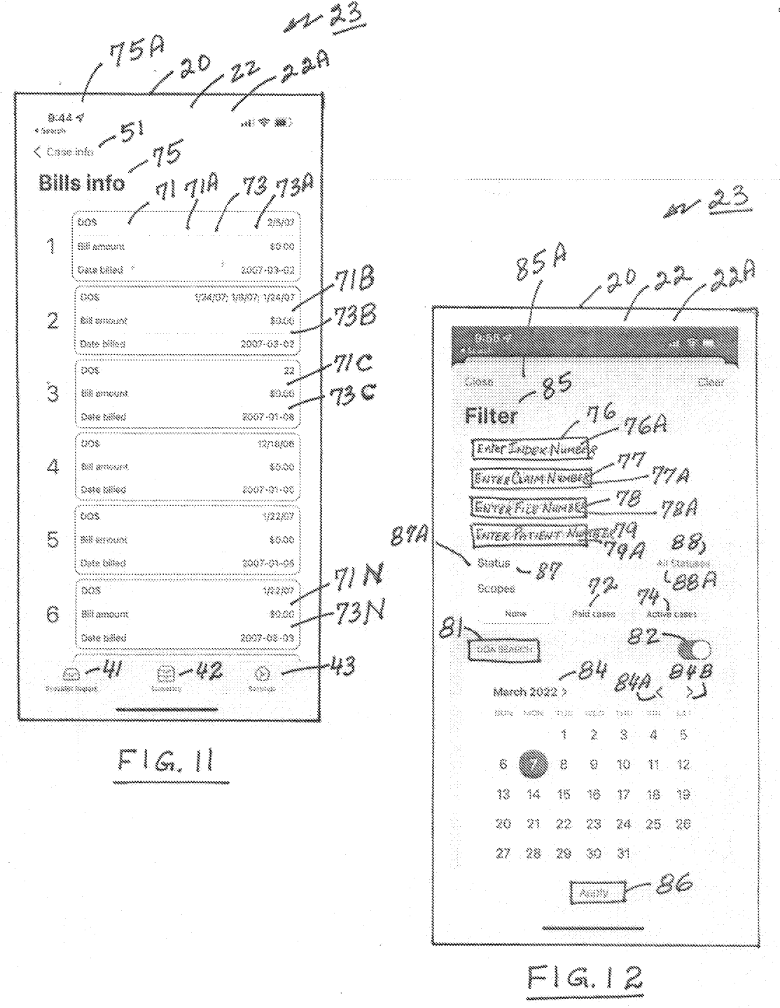

FIGS. 6, and 7, are a screenshot of an electronic device 20, having a display screen 22, for the inventive App 23, illustrating a Case info or information 51, on a first case info screen or page 51A. The first case info screen or page 51A, is reached when a user clicks on the file number button 50A, illustrated in FIG. 5. The first case info screen or page 51A, has some information that is available on the bills report screen or page 40A, as it is a continuation of the same case or file number 50, but now has some additional or more information 46. For the purposes of illustration the additional or more information 46, for the case number 45A, could be, for example, “Date answer received”, “Date served”, “Index number”, “D's” or defendant's attorney, to name a few. The first case info screen or page 51A, could also have additional information, such as, for example, “Future appearance” 56, where additional information could be obtained by clicking or activating the button 56A, a field for “Memo” 55, where additional information could be inputted or provided in the area 55A, a “DOCS” or document field 58, where additional information could be obtained by clicking or activating the docs button 58A, to name a few, and where clicking on the docs button 58A, a user would be taken to a second case information screen or page 52A, illustrated in FIG. 8. The first case info screen or page 51A, could also have a “Bill info” 25, which could be activated by clicking or activating bill info button 25A, which would take the user or a bills info screen or page 75A, illustrated in FIG. 11. It should be appreciated that in the Case Info 51, screen a user can view balances, motions, trials, appeals, all supporting info, to name a few. Furthermore, in the Memo box 55, one could provide all the law office notes for that specific case.

FIG. 8, is a screenshot of an electronic device 20, having a display screen 22, for the inventive App 23, illustrating a second page 52, for the Case info or information 51, on a second case info screen or page 52A, and is related to uploading document(s) onto a server (not shown) for a specific case. The second case info screen or page 52A, is reached when a user clicks on the does button 58A, illustrated in FIG. 7. The second case info screen or page 52A, could have additional information, such as, for example, files 59, which could be obtained by clicking or activating a file button 59A, which would be associated with each obtainable file 59. The file(s) 59, could be in a number of known formats, such as, for example, a pdf format, a Word format, a WordPerfect format, an Image format, a JPEG format, Excel format, EML format (email), and combinations thereof, to name a few.

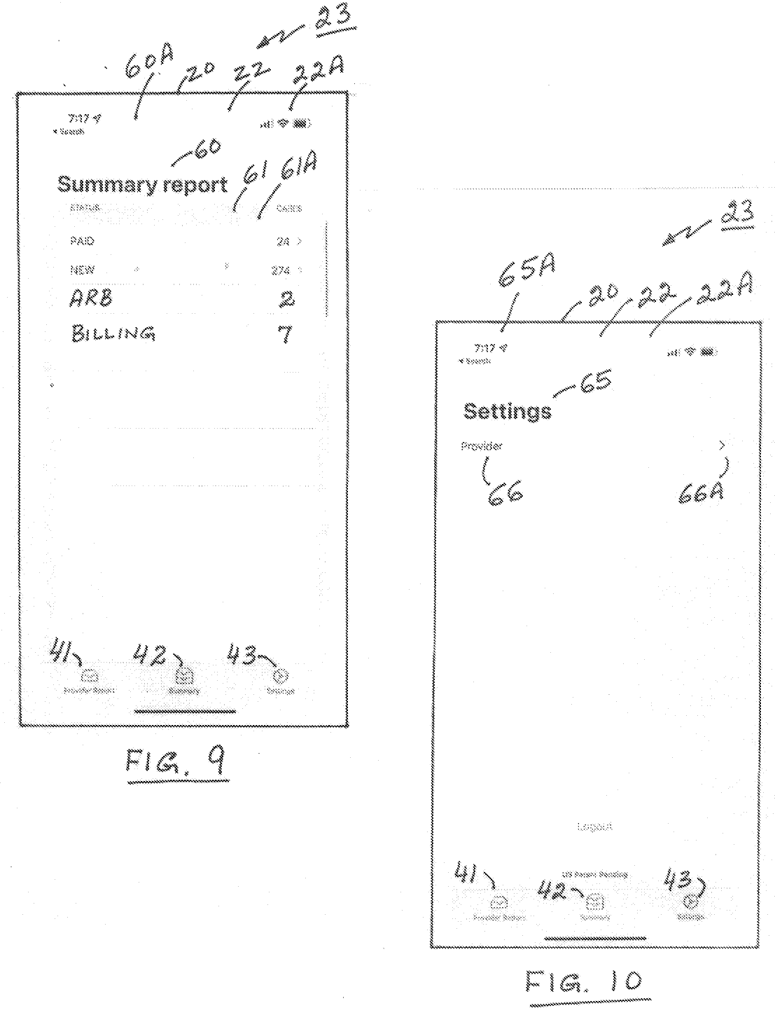

FIG. 9, is a screenshot of an electronic device 20, having a display screen 22, for the inventive App 23, illustrating a Summary report 60, on a summary report screen or page 60A. The summary report screen or page 60A, is reached when a user clicks on the summary button 42A, of the summary logo 42, illustrated in FIG. 4, or from any of the other screens or pages that contain the summary logo 42. On the summary report page or screen 60A, a user can access additional summary information 61, by clicking or activating a report button 61A, associated with the additional information 61, such as, for example, the number of cases is Arbitration (ARB), the number of cases pending in the Billing process, the number of New cases, the number of cases where the Insurance companies have Paid, or a Settlement has been done, to name a few. It should be appreciated that the Summary Report 60, provides a user a status summary report for the related cases for a medical office, and it can be filtered for each status.

FIG. 10, is a screenshot of an electronic device 20, having a display screen 22, for the inventive App 23, illustrating a settings 65, on a settings screen or page 65A. The settings screen or page 65A, is reached when a user clicks on the settings button 43A, of the settings logo 43, illustrated in FIG. 4, or from any of the other screens or pages that contain the settings logo 43. On the settings page or screen 65A, a user can access additional settings information 66, such as, for example, a provider 66, by clicking or activating a provider button 66A, associated with each provider 66. The user can also change provider 66, by clicking or activating the provider button 66A.

FIG. 11, is a screenshot of an electronic device 20, having a display screen 22, for the inventive App 23, illustrating a Bills info or information 75, on a bills info screen or page 75A. The bills info screen or page 75A, is reached when a user clicks on the bills info button 25A, in FIGS. 6, and 7. On the bills info page or screen 75A, the user would get additional bill information 71, in a bill info field 73, such as, for example, DOS (Date of Service), Bill amount, Date billed, to name a few, for the specific case 45, 51. The bills info page or screen 75A, could have additional bill information 71A, 71B, 71C, . . . , 71N, in the bill info field 73A, 73B, 73C, . . . , 73N.

FIG. 12, is a screenshot of an electronic device 20, having a display screen 22, for the inventive App 23, illustrating a Filter 85, on a filter screen or page 85A. The filter screen or page 85A, is reached when a user clicks on the filter button 80A, illustrated in FIG. 5. On the filter page or screen 85A, a user would get additional information, such as, for example, “Enter an index number” 76, using a button or field 76A, “Enter claim number” 77, using a button or field 77A, “Enter file number” 78, using a button or field 78A, “Enter patient name” or an injured person's name 79, by using a button or field 79A, checking the “Status” 87, of a specific case, by using a button or field 87A, checking “All Statuses” 88, by using a button or field 88A, to look at all the pending cases or all cases, etc. The filter page or screen 85A, could also be provided with additional fields, such as, for example, narrowing a search by using “Use Date” or a date range, such as, for a given year, or a year range, or a month, or a month range, or a day, or a day range, and combinations thereof. The Filter page or screen 85A, could also have additional features or buttons, such as, for example, a “DOA” (Date of Accident) search button 81, an ON/OFF button 82, an “Apply” button 86, a “Paid cases” button 72, “Active cases” button 74, along with a monthly calendar 84, which could be scrolled using backward calendar arrow 84A, and a forward calendar arrow 84B, to name a few.

It should be understood that this inventive App 23, allows all users, namely, an injured person, an employee of a law firm, an employee of an insurance company, a medical services provider, and combinations thereof, to name a few, to access the inventive App 23, by logging in using a username 12, and a password 14, as discussed in FIG. 1, and then be able to freely move about the other pages or screens within the inventive App 23. For the sake of security and privacy only the law firm employees or agents or user would be able to access and see all the pages or screens of the inventive App 23, whereas other users would only be able to see information that either pertains to them or they have been authorized to see, for example, a user A, will not be able to see the information of user B, unless user B, has been authorized by either user A, or an administrator responsible for the inventive App 23. Thus, a user who is an injured person and a client of the law firm 10, will be able to see most all of the information, as the injured person is directly benefiting from the monies being spent on his/her behalf, or being generated on his/her behalf. Similarly, a medical provider who is working on behalf of the law firm 10, or the injured person would only be able to see the various invoices that they have generated, and the ones that have been paid or are pending. Similarly, an insurance company will be able to see all the disbursement the law film 10, has done on behalf of the injured person, or the pending invoices by the medical providers P, 30, or what amount the insurance company needs to pay to satisfy the medical liability insurance portion of the injured person's claim.

It should be appreciated that the inventive App 23, is preferred to be used as a smartphone App 23, which would be downloaded from over the Internet onto a cellular device or a mobile phone. The inventive smartphone App 23, can be used on a number of platforms, such as, for example, Windows, Mac, IOS, iPhone, Android, and combination thereof, to name a few. Furthermore, this inventive App 23, allows a user, such as, for example, a client or a law firm to perform a full audit for a particular case or for all cases managed by a law firm. This full audit becomes important, especially, for example, an injured person wants to know how much money was charged by a medical provider P, 30, to the law firm 10, or how much money the law firm 10, has dispersed to various entities, or how much money has been collected by the law firm 10, such as, from an insurance company, or a defendant, or from arbitration, to name a few. The inventive App 23, also allows a user to perform analytical analysis for any and all information contained within the inventive App 23. This analytical analysis could be done by, for example, a provider, a plaintiff's attorney, a defendant's attorney, an insurance company, a court order, to name a few. This inventive App 23, also allows for digital recording and maintenance record of all incoming and outgoing payments. The digital record keeping using the inventive App 23, becomes very important for keeping records of accurate payments between the law firm, and the other entities, such as, for example, an insurance company, a medical provider, etc. This inventive app 23, helps to avoid loss of payment(s) to the law firm, by the various entities, such as, for example, an insurance company, a workman's compensation payment, a court judgment, an arbitration award, to name a few.

It should also be appreciated that the inventive App 23, is a universal user App 23, where it is actually owned or managed by a law firm 10, but it is accessible to all users or parties who have some interest related to an injured person, such as, a medical provider P, 30, that will provide medical services to an injured person, or bill for the medical services provided to an injured person, or be paid for the medical services provided to an injured person, an insurance company that is going to pay compensation to an injured person, or manage monies disbursed on behalf of an injured person, an injured person who wants to know what all is going on with money or medical or legal procedures relating to their personal injuries, a law firm that is overall managing all the issues relating to the injuries of the injured person, to list a few. Thus, each entity can easily access the inventive App 23, and easily be able to see the information relating to issues or information of interest to them in real time, and do not have to get any additional approval or authorization to see such information, thus this is a universal user App 23, where each user to entity can freely move about the inventive App 23, and the owner or law firm 10, does not have to control or manage “need to know” protocols for the diverse population of the users.

For the purposes of simplicity, the Applicant is using “Insurance Company”, but this Application could be used by any law firm handling bodily injury matters, workman compensation matters, personal injury matters, to name a few, and in those situations one would either just change the name of the field, or change the name of the identifier label, etc., which can be easily done via either a software update, or by coding the software for that specific area or industry.

It should also be understood that this inventive App 23, could also have additional fields, which are currently not shown or identified, but those fields could be as a result of a specific need, or a user's requirement, or due to other reasons, such as, for example, the changing needs or the industry, or any legal requirements, or any customization by a user, to name a few. Similarly, for the ease of understanding standard features, such as, for example, forward arrows to go to the next page or screen, or back arrows to go back to a previous page or screen, are not being shown or illustrated in the various pages or screens, as they are all well known to a person skilled in the art.

The inventive App 23, of the preset invention may be implemented using one or more computers or electronic devices 20, executing software instructions. According to one embodiment of the present invention, the electronic device(s) 20, may communicate with a server, or a client computer systems that transmit and receive data over a computer network or a fiber or copper-based telecommunications network or a wireless communication network or a Wi-Fi communication network, to name a few. The steps of accessing, downloading, and manipulating the data, as well as other aspects of the present invention are implemented by one or more central processing units (CPU) in the server, or client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server or client computers from a storage device or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the CPU may directly support the downloaded instructions. In other cases, the instructions may not be directly executable by the CPU, and may instead be executed by an interpreter that interprets the instructions. In other embodiments, hardwired circuitry may be used in place of, or in combination with, software instructions to implement the present invention. Thus tools used in the present invention are not limited to any specific combination of hardware circuitry and software, nor to any particular source for the instructions executed by the server or client computers. In some instances, the client and server functionality may be implemented on a single computer platform.

Thus, the present invention is not limited to the embodiments described herein and the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

Still further, while certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the invention.

It should be further understood that throughout the specification and claims several terms have been used and they take the meanings explicitly associated herein, unless the context clearly dictates otherwise. For example, the phrase “in one embodiment” as used herein does not necessarily refer to the same embodiment, though it may. Additionally, the phrase “in another embodiment” as used herein does not necessarily refer to a different embodiment, although it may. Thus, various embodiments of the invention may be readily combined, without departing from the scope or spirit of the invention.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. An apparatus for managing communications between users, comprising;
(a) at least one electronic device having a device screen, and at least one software management system;
(b) said software management system being accessible to a user via a login page visible on said device screen;
(c) wherein upon login said user has access to at least one first page, wherein said at least one first page has information related to a personal injury of at least one person;
(d) wherein said at least one first page allows said user to obtain said information related to said personal injury of said at least one person; and
(e) wherein said user is limited to seeing information related to said at least one injured person that pertains to said user.

2. The apparatus for managing communications between users of claim 1, wherein said user is selected from a group consisting of an injured person, an employee of a law firm, an employee of an insurance company, and a medical services provider, and combinations thereof.

3. The apparatus for managing communications between users of claim 1, wherein said at least one electronic device is selected from a group consisting of a smart phone, a tablet, a computer, a laptop, a mobile electronic device, and combinations thereof.

4. The apparatus for managing communications between users of claim 1, wherein said at least one first page is selected from a group consisting of, a provider page, a summary page, a bills report page, a case info page, a summary report page, a settings page, a bills info page, a filter page, and combinations thereof.

5. The apparatus for managing communications between users of claim 4, wherein said provider page has at least one list of at least one medical services provider, and wherein said user directly accesses additional information related to said at least one medical services provider.

6. The apparatus for managing communications between users of claim 4, wherein said summary page has information related to at least one case in litigation, at least one status report for at least one case, at least one report on at least one receivable, and a summary of amount to collect, amount billed, and amount voluntarily paid by an insurance company.

7. The apparatus for managing communications between users of claim 4, wherein said case info page has information providing at least one pending legal proceeding in court.

8. The apparatus for managing communications between users of claim 4, wherein said case info page has information providing at least one pending legal proceeding in court, and wherein said at least one legal proceeding is selected from a group consisting of at least one motion related to said personal injury of said at least one person.

9. The apparatus for managing communications between users of claim 4, wherein said summary report page has information providing information related to a group consisting of at least one paid amount, at least one billed amount, at least one amount in arbitration, and combinations thereof.

10. The apparatus for managing communications between users of claim 1, wherein said provider page has a list of at least one medical services provider, and wherein said at least one medical services provider list further has at least one active button to take said user to additional information related to said at least one medical services provider.

11. A method of managing communications between users, comprising the steps of;
(a) making a user login onto a welcome page of an app by entering a username and a password;
(b) authenticating said user, and taking said user to a user agreement page;
(c) upon agreeing with said user agreement, allowing said user to enter said app, and wherein said app provides information related to at least one injured person;
(d) wherein said user is one of said at least one injured person, an employee of a law firm, a medical services provider, an insurance company employee, and combinations thereof; and
(e) wherein said user is limited to seeing information related to said at least one injured person that pertains to said user.

12. A non-transitory computer-readable storage medium with an executable program application stored thereon, the program application configured for coordinating to perform transactions associated with managing communications between users, the program application configured to be accessible over a communications network, wherein the program application instructs a computer processor to perform the following steps of:
(a) making a user login onto a welcome page of an app by entering a username and a password;
(b) authenticating said user, and taking said user to a user agreement page;
(c) upon agreeing with said user agreement, allowing said user to enter said app, and wherein said app provides information related to at least one injured person;
(d) wherein said user is one of said at least one injured person, an employee of a law firm, a medical services provider, an insurance company employee, and combinations thereof; and
(e) wherein said user is limited to seeing information related to said at least one injured person that pertains to said user.
